(19) United States
(12) Patent Application Publication
(10) Pub. No.: US 2005/0188004 A1
(43) Pub. Date: Aug. 25, 2005

(54) State-dependent information serving

(76) Inventors: Martin Bergenwall, Espoo (FI); Kalevi Ratschunas, Espoo (FI); Juhani Murto, Helsinki (FI)

Correspondence Address: COHEN, PONTANI, LIEBERMAN & PAVANE, 551 FIFTH AVENUE, SUITE 1210, NEW YORK, NY, 10176, US

(21) Appl. No.: 10/182,339

(22) PCT Filed: Jan. 26, 2001
(86) PCT No.: PCT/IB01/00258

(30) Foreign Application Priority Data
Jan. 28, 2000 (GB) 0002066.9

(51) Int. Cl. G06F 15/16

(52) U.S. Cl. 709/203

(57) ABSTRACT

A method for providing state-dependant information to a terminal operable in communication with a communication network including a server unit, the method comprising: receiving at the server unit a request from the terminal for data; determining the state of the terminal by means of the server unit; requesting by means of the server unit state-dependent data dependant on the state of the terminal and corresponding to the requested data, the server unit transmitting a request for the state-dependent data that includes an indication of the determined state of the terminal; receiving at the server unit the state-dependant data; and transmitting the state-dependant data to the terminal.

This invention relates to the serving of information that includes one or more elements that are dependant on the state of a terminal receiving the information. The said state could, for example, be the location of the terminal.

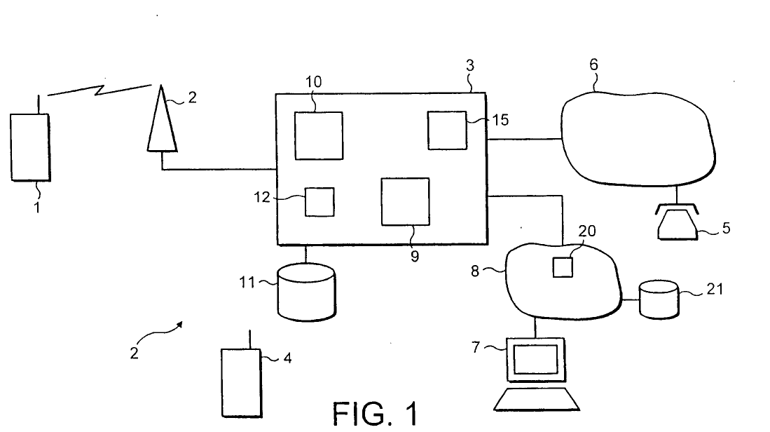

FIG. 1 illustrates a mobile station 1 such as a mobile phone or other terminal operating in communication with the fixed apparatus of a mobile communication network 22. The network comprises at least one base station 2 that can communicate by radio with the mobile station 1, and network apparatus 3 that can control the operation of the network to allow communications to be connected between the mobile station and other terminals. Those other terminals may include another terminal 4 of the mobile network 2, a terminal 5 of a land-line telephone network 6 connected to the mobile network, or a data terminal 7 connected to a data network 8 such as the internet that is also connected to the mobile network. The network equipment 3 includes, for example, equipment such as base station controllers, a mobile system controller, a visitor location register and a home location register, for instance in accordance with the GSM (global system for mobile communications) standard.

In addition to voice traffic, the network equipment can provide packet data traffic to the mobile station, for example using GPRS (general packet radio service). To facilitate this the network equipment includes a GGSN (gateway GPRS support node) 10, and it also includes an SGSN (serving GPRS support node) 9. The GGSN can receive data such as world-wide web pages in packet format and route it to the mobile station 1. Such data may be held on a server 11 remote from the network apparatus, and provided to the GGSN by that server on request. The data received from the server may be returned to the GGSN and MS via a proxy server 12. The proxy server may cache received data so that if the same data is requested again it can serve that request from its cache rather than requiring the data to be sent again from a remote store.

The network apparatus may include a location centre 15. The location centre is capable of determining the location of a mobile station in the mobile network, for example by means of triangulation using timing delays and/or signal strength information as between the mobile station and base stations of the network. The location centre can be accessed by other of the network apparatus in order to learn the location of a specified mobile station, or by a mobile station itself in order to establish its own location.

When mobile station 1 requests information such as a world-wide web page it transmits a request for the page to the mobile network. The request is routed to the GGSN via the SGSN. The GGSN transmits a request for the page to routing equipment 20, which causes the request to be routed to the appropriate server 21. The server 21 replies with the requested page data. The page data is forwarded in GPRS format from the GGSN to the mobile station 1. The mobile station 1 can then display the page to a user. As previously described, the request for data and the reply data may be routed via a proxy server which may cache the page so that if it is later requested again the page can be supplied from the proxy server's cache.

The indication of client location to a content server in HTTP content negotiation is known from MExE (mobile execution environment) stage 2 [03.57]. In MExE the client location type can be a cell, GPRS (routing area), geographic area in the form of co-ordinates obtained using E-OTD, TOA (time of arrival) or other methods. However, the MExE system does not provide for and has not been integrated with the determination of client location. Web page requests conventionally include an indication of the web browser properties being used at the client. This indication is generated by the client itself. In many circumstances it would be acceptable for client location (if it could be determined) to be indicated in an analogous way by the client itself. However, the inventors of the present invention have appreciated that in, for example, a radio telephone system the indication of client location by the client (radio telephone) may involve high network traffic as location-dependant information is served, which could reduce the capacity of the network for other communications.

It would therefore be desirable for there to be the facility for a terminal to be able to receive web pages or other information for presentation to a user that is dependant on the state (e.g. the location) of the terminal that is to receive and display it.

According to the present invention there is provided a method for providing state-dependant information, and a communication system as set forth in the accompanying claims.

The present invention will now be described by way of example with reference to the accompanying drawings, in which:

FIG. 1 illustrates a communication system;

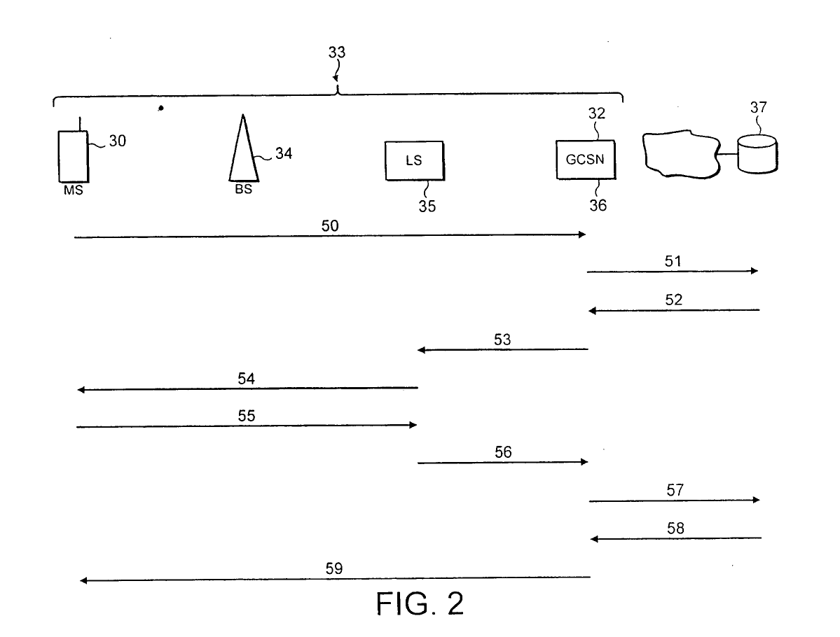

FIG. 2 illustrates communication flow in a method for supplying a terminal with data; and

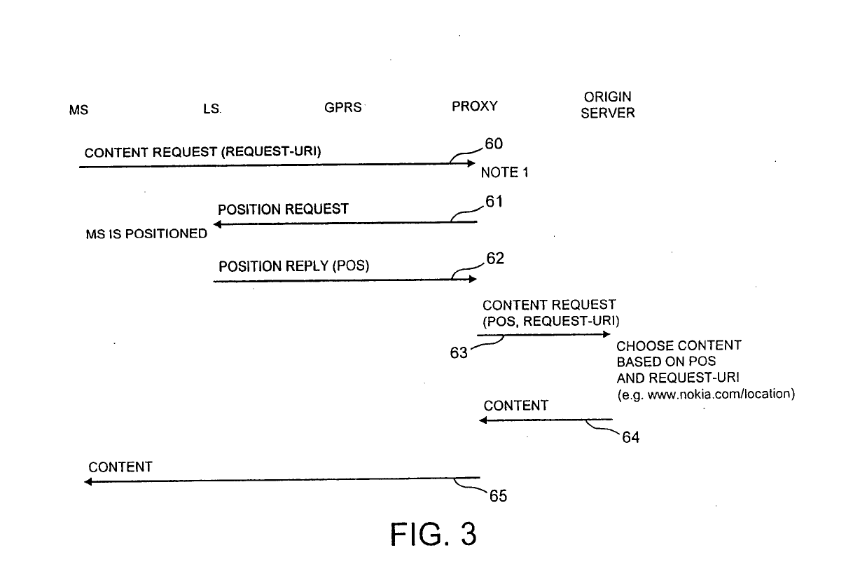

FIG. 3 illustrates communication flow in a method for supplying data by means of a proxy server.

FIG. 2 illustrates a communication flow whereby a mobile station 30 is provided with data such as a web page from a remote store 37. The web page includes data that is dependant on the status of the mobile station. The web page is supplied to the mobile station via a serving unit 32 which is, in this example, part of the mobile communications network 33 in which the mobile station is operating. On receiving the web page, the serving unit 32 detects whether the page includes information indicative of a dependence on the status of the mobile terminal in the mobile network 33. On detecting such information the serving unit 32 determines that status of the mobile station, and then returns that information to the remote store 37. In response the remote store returns the status-dependant web page data to the serving unit 32. The serving unit then provides the web page including the status-dependant data to the mobile terminal. The mobile terminal can then present the web page to a user, for example by visual or audio means. The status of the mobile station on which the data is dependant may, for example, be the location of the mobile station. Since the status of the mobile station is indicated on the network side (by the serving unit 32), rather than by the mobile station 30, there is no need for the initial web page to be transmitted over the air to the mobile station, or for the response to be transmitted over the air to the network side. The present system offers significantly reduced bandwidth over such a client-based approach.

A world-wide web (WWW) page in HTML (hyper-text mark-up language) can include codes for formatting of text and images on the page, and for indicating factors on which the processing and/or presentation of the page is to be dependant. An HTML page could include a code (e.g. as meta data) indicating that the entire page or a sub-part of it is dependant on the status of a terminal that is to receive and/or display the page—for example on the location of such a terminal. In response to the detection of such information the status of the terminal may be determined and the status-dependant data obtained and displayed together with any other data of the page.

It may be possible for the receiving terminal itself to detect status-dependent information, and then to determine that status of itself, and request and receive the status-dependant information. However, as indicated above, this would require additional signalling between the terminal and the network with which it is in communication. In an environment where communications to the terminal are severely bandwidth limited—for example in a mobile communication system—such an arrangement causes additional load on the system. This is especially relevant in networks in which communication resources are shared between a number of terminals: for instance in a CDMA (code division multiple access) radio communication system in which there can be direct interference between concurrent users of the system. There would therefore be great advantages in a system that permitted status-dependant information to be served to a terminal such as a radio-linked mobile station without substantial increases in bandwidth to the terminal. Such a system can be provided as described below.

The present invention will now be described in more detail for the example where the served data is a web page, and the status on which at least some of the data is dependant is the location of a receiving terminal. Other forms of data and other types of status may be used instead.

FIG. 2 illustrates schematically the relevant components of a mobile communication system including a mobile communication network 33 in which a mobile station 30 is operable. The mobile station can communicate with the network by radio to one or more base stations 34. In addition to the normal components the mobile communication network includes a location server 35 and GGSN unit 36.

On receiving a request for the location of a specified mobile station the location server can estimate the location of the mobile station, for example by means of triangulation using radio signal delays, timing differences or received signal strength between the mobile station and a plurality of the base stations 34; or by specifying the location of a cell in which the mobile station is communicating. The location server 35 can then respond with a message reporting on the location of that mobile station. The location can be reported, for example, in national grid format, as latitude and longitude or as distances from standard location points. To reduce processing requirements and network load the location unit could store the location of a mobile station once it has been determined, and allot that location validity for a limited period of time. Subsequent requests for the location of that mobile station could be responded to with the stored location until such time as its validity expires—for example after 5 or 30 minutes from the estimation of that mobile station's location. The reduction in processing and network load afforded by this approach could be a significant advantage if location-dependant pages were being served frequently. The time of validity could be dependant on the recent and/or average velocity of the mobile station: a fast-moving mobile station could be assigned (at least temporarily) a short validity period.

The GGSN unit 36 operates to service data traffic to and from the mobile stations connected to network 33. The GGSN unit can communicate with such mobile stations using the GPRS protocol, and with other units—such as unit 37 connected to the internet—using an appropriate protocols such as TCP/IP (transmission control protocol/internet protocol). The proxy server also provides a proxy service to the mobile stations connected to network 33 and may also cache received data to allow that data to be served directly to mobile stations without it having to be requested from a remote site. Proxy and/or caching may be provided at the GGSN unit or elsewhere.

The mobile station may include web browsing software by means of which it can generate a request for a web page. (Message 50 in FIG. 2). The proxy unit transmits a corresponding request for the same page to the appropriate network (e.g. to the internet), where it is directed in the normal way to the storage unit (e.g. unit 37) that holds the requested page. (Message 51). The storage unit responds with the data that defines the page. (Message 52).

The transmitted data that defines the page may include one or more elements that indicate that the page itself or sub-page information that goes to make up the page can be provided in a location-dependant manner. For example, the requested page may be a restaurant guide which can be provided so as to list restaurants in the area in which the user requesting the page is located, or the page may include a graphic file for an embedded advertisement banner which is to display an advertisement for a service local to where the user is located. This location-dependence could be indicated by means of coding embedded in the HTML formatting making up the page. In some circumstances location dependence could be available only for terminals at some locations—for example if local advertising banner space has been sold for only a limited set of locations. In that case the indication of location dependence could include an indication of the areas where such location dependence is valid—for example within specified radii of specified locations.

The proxy unit scans the received page data for indications of dependence on the status of the requesting mobile station. If none is found then the page is sent to the mobile station by the proxy server. If such an indication is found—for example indicating location dependence—then the proxy server transmits a request to the location centre 35 for the location of the mobile station. (Message 53). By means of signalling with the mobile station if necessary—for example to determine timing delays to the mobile station in broadcast signals from the network—(messages 54, 55), the location centre determines the location of the mobile station and returns that to the proxy server 36 by means of message 56. The proxy server then transmits towards the appropriate store a page request indicating the location of the unit that is to present the page. (Message 57). Such a page request could be of the form:
Browser: wwwww
Ref URL: http://xxxx.xxxx.xxxx
Location: yyyy.yyyy
GET “zzzz.htmll”

This is the same as a conventional HTTP page request but with the addition of the location field, in which the abbreviation “yyyy.yyyy” above represents the indicated location. Thus, by adding the “location” field to a conventional page request the location of the receiving unit can be indicated. Such a request is likely to have good compatibility with existing web servers, which could just ignore the “location” field. The modified location-specifying request could be generated by the proxy server merely inserting the location field into the request originally sent by the mobile station. The field “GET” indicates the identity of the page that is to be retrieved from that URL. The field “browser” indicates the form of web browser that is in use by the receiving unit. More information on the HTTP protocol is available from http://www.w3.org, for example at http://www.w3.orq/Protocols/rfc2616/rfc2612.html Alternative means for the location information to be provided to a server are in an application-dependant part of the conventional request (e.g. in the specified URL or page identity) or by means of a cookie.

The store then processes the request, including the location data, and generates or retrieves the page or sub-page data that is to be sent to satisfy the request. That is transmitted to the proxy server. (Message 58). Finally, the proxy server transmits the received location dependant page data to the terminal (message 59) which presents the data to a user by displaying it or otherwise.

If the proxy server is unable to determine the location of the mobile station then it could provide the mobile station with the default page as initially received from the store, or could request a non-location-dependant version of the page from the store and supply that to the mobile station.

The proxy server could cache received web pages, as described above. It could additionally cache location-dependant pages. FIG. 3 shows information flow in one situation where the location-dependant information is provided via proxy server. In FIG. 3 a message 60 is sent from a mobile station (MS) to the proxy server (PROXY) to request data such as a web page. The proxy determines by means such as analysis of the identity of the requested data (see below) that the requested data is location-dependant or available in a location-dependant form. The proxy sends a position request message 61 to a location server (LS) to request the location of the mobile station MS. The location of the MS is determined and the location server returns the location in message 62. The proxy server then sends a message 63 to the source server (ORIGIN SERVER) for the requested data. Message 63 includes information specifying the location of the mobile station. The origin server retrieves the requested data and transmits it to the proxy server in message 64. The proxy server forwards the data to the mobile station in message 65. An alternative arrangement would be for the proxy not to analyse the identity of the requested data: the position of the mobile station may be provided to the source server irrespective of whether it wishes to know the mobile station's position. In this case, the positioning request may be based on other information available to the proxy server such as a parameter within the data (content) request message or the identity of the requesting subscriber, such as the source address of the request message or another subscriber identity carried in the message. The positioning request may also be based on user or terminal information stored in association with the proxy, such as terminal capability information.

The proxy server could use other information to determine whether a page is location-dependant or not. That other information could, for example, be the URL of the page or another part of the message that requests the page. In the URL the specified domain name (e.g. www.nokia.com) could be compared with the contents of a stored lookup table indicating domains for which location information is needed. Alternatively, or in addition, the resource part of the URL could be compared with the contents of a stored lookup table indicating resource parts for which location information is needed. A string such as “/location” could be used in the resource part of a URL to indicate that location information is needed. The lookup table(s) could be stored at the proxy server itself or elsewhere. If the table(s) are stored elsewhere then the unit at which they are stored could respond to the proxy server with a status message indicating whether or not positioning is needed. These functions provide the facility for the mobile station's location to be determined only for certain web pages and/or for data from certain servers. Such servers could thus be specific servers for position-sensitive information.

As explained above, the mobile station itself could determine its location having detected the location-dependent web page. However, this may involve greater network traffic and may provide fewer opportunities for increasing efficiency by means of caching.

The location of the mobile station could be determined in other ways, for example by GPS (global positioning system) or network assisted GPS.

For security, it is highly preferable that a mobile station should be able to disable provision of location data. This could be done by means of an instruction to the network, or by a code included in each page request it makes that is not to be made with location information. Most preferably, a user of the mobile terminal should be able to enable or disable location sending for specified sites or classes of sites. This would allow a user to agree to the provision of trusted sites with location information but to withhold such information from other sites. Also, if the user is charged by the network operator for the provision of location information then the user may well want to disable locating services to reduce costs.

Instead of being dependent on the location of the receiving terminal the data could be dependant on one or more other aspects of the status of the mobile station. Those aspects are preferably aspects of its status within the communication network (e.g. the radio communication network) within which it operates. Those aspects are suitably not inherent aspects of the status of the terminal itself. For example, the information could be dependant on the network services to which the terminal has subscribed, the recent velocity of the terminal (as detected by changes in its position over time) or the usage patterns of the terminal. The aspect of status is preferably determinable without substantial interrogation of the terminal itself, so that the proxy server, together with other network equipment can determine that status without substantial use of radio communication bandwidth with the terminal.

The proxy server need not be located at or associated with the GGSN unit. However, it is preferably located either at a GGSN unit (or the equivalent) or between there and an external network that is to provide the requested data. Instead of a GGSN unit operable with GPRS a unit of another type could be used.

The principles described above could be used for other forms of data than web pages, for example WAP (wireless access protocol data or files), FTP (file transfer protocol) data or files, or any other appropriate form.

The network with which the mobile station operates, and in which the proxy server and location centre are located is preferably a radio telecommunications network and/or a mobile communications network such as a mobile telephone network. The mobile station is suitably capable of communicating by radio with the network. The mobile station is preferably a moveable unit, but could be of fixed location for example if it is providing communications for a building.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

1. A method for providing state-dependant information to a terminal operable in communication with a communication network including a server unit, the method comprising:
receiving at the server unit a request from the terminal for data;
determining the state of the terminal by means of the server unit;
requesting by means of the server unit state-dependant data dependent on the state of the terminal and corresponding to the requested data, the server unit transmitting a request for the state-dependent data that includes an indication of the determined state of the terminal, the said requesting step being performed in response to receiving at the serer unit primary data including an indication of the availability of corresponding state-dependant data dependant on a state of a terminal;
receiving at the server unit the state-dependant data; and
transmitting the state-dependant data to the terminal.

2. A method as claimed in claim 1, wherein the said state of the terminal is the location of the terminal.

3. A method as claimed in claim 2, wherein the network includes a location determining unit, and the step of determining the said state of the terminal comprises determining the location of the terminal by means of the location determining unit.

4. A method as claimed in claim 3, wherein the location determining unit determines the location of the terminal by means of characteristics of radio communications between the terminal and the network.

5. A method as claimed in claim 4, wherein the said characteristics are timing differences.

6. A method as claimed in any of claims 3 to 5, comprising the step of the location determining unit communicating the determined location to the server unit.

7. A method as claimed in any preceding claim, wherein the server unit is a proxy unit.

8. A method as claimed in any preceding claim, wherein the server unit is capable of caching received data for transmission to other terminals.

9. A method as claimed in any preceding claim, comprising the step of the terminal presenting the state-dependant data to a user.

10. A method as claimed in any preceding claim, wherein at least one of the primary data and the state-dependant date is world-wide web (WWW) data.

11. A method as claimed In any preceding claim, wherein at least one of the primary data and the state-dependant data is conveyed to the server unit by means of hypertext transfer protocol (HTTP).

12. A method as, claimed in any preceding claim, wherein the state-dependant data is conveyed to the terminal by means of general packet radio service (GPRS).

13. A method as claimed in claim 12, therein the server unit is located at a global general packet radio service serving node (GGSN).

14. A method as claimed in any preceding claim, wherein the primary data and the state-dependant data are communicated to the server unit via the internet.

15. A method as claimed in any preceding claim, wherein the server unit requests the state-dependant data by means of a hypertext transfer protocol (HTTP) page request.

16. A method as claimed in claim 15, wherein the hypertext transfer protocol (HTTP) page request includes data indictive of the location of the terminal.

17. A method as claimed in any preceding claim, comprising the step of the terminal requesting the primary data.

18. A method as claimed in claim 17, wherein the terminal requests the primary data by way of the server unit.

19. A method as claimed in any preceding claim, wherein the network is a mobile communication network.

20. A method as claimed in any preceding claim, wherein the terminal is a mobile station.

21. A method as claimed in claim 20, wherein the terminal is a mobile telephone.

22. A method as claimed in any preceding claim, wherein the terminal is mobile.

23. A method as claimed in, any preceding claim, comprising the steps of receiving at the server unit data having an associated data identifier, comparing at least part of the data identifier with the contents of an identifier database, and performing the said step of requesting state-dependant data in response to the result of that comparison.

24. A method as claimed in claim 23, wherein the data having an associated data identifier data is data specified in the said request for data.

25. A method as claimed in claim 23 or 24, wherein the data identifier is a universal resource locator.

26. A method as claimed in any preceding claim, wherein the step of requesting the state-dependant data comprises requesting the state-dependant data from a data server.

27. A method as claimed in claim 26 as dependant on any of claims 23 to 25, wherein the identity of the data server is specified in the data identifier.

28. A method as claimed in claim 26 or 27, wherein the step of requesting the state-dependant data comprises transmitting to the data server a request for the state-dependant data, the request including information indicative of the location of the terminal.

29. A method as claimed in any preceding claim, wherein the state dependant data is wireless application protocol content.

30. A communication network comprising a server unit adapted to receive primary data, detect within the primary data an indication of the availability of corresponding state-dependant data dependant on a state of a terminal, determine the said state of the terminal; request state-dependant data dependant on the determined state of the terminal, receive the state-dependant data and transmit the state-dependant data to the terminal.
